(19) United States
(12) Patent Application Publication
(10) Pub. No.: US 2011/0199727 A1
(43) Pub. Date: Aug. 18, 2011

(54) TABLET COMPUTER CASE AND ASSOCIATED METHODS

(76) Inventor: Brian Probst, Orem, UT (US)

(21) Appl. No.: 13/016,830

(22) Filed: Jan. 28, 2011

Related U.S. Application Data
(60) Provisional application No. 61/298,974, filed on Jan. 28, 2010.

(51) Int. Cl. G06F 1/16

(52) U.S. Cl. 361/679.09

(57) ABSTRACT

Tablet computer cases and associated methods are disclosed and described. In one embodiment, a clam shell keyboard case may include a tablet panel with a hollowed out bed defined by a recessed back surface and a raised perimeter edge extending around the recessed back surface. The perimeter edge can have an internal shape and size substantially matching a shape and size of an external perimeter edge of a tablet computer to be held in the hollowed out bed. The tablet panel can be hingedly coupled to a keyboard panel having a keyboard. When a tablet computer is held in the hollowed out bed of the tablet panel, the keyboard can be used for input and/or control actions with respect to the tablet computer.

### PRIORITY DATA

This application claims the benefit of U.S. Provisional Patent Application Ser. No. 61/298,974 filed on Jan. 28, 2010 which is incorporated herein by reference.

### FIELD OF THE INVENTION

The present invention relates to cases for tablet computing devices and related methods. Accordingly, the present invention involves the fields of electronics, material science, and mechanical engineering.

### BACKGROUND OF THE INVENTION

Tablet computers such as Personal Digital Assistants (PDA), cellular phones, and the computing device recently released by Apple Corporation under the trade name IPAD® have become increasingly popular. The simple and slim form factor of such devices is one reason. Another reason is that many of such devices come with a touch sensitive screen, or “touch screen” where user input and computing control are engaged by simply touching the digital display screen. One pioneering example is the cellular phone marketed by Apple under the trade name IPHONE®. This phone has a touch screen that allows navigation of computing function, such as internet navigation, program engagement, and communication (i.e. placement of calls, generation of e-mail, and creation of text messaging) all by directly touching the screen or visual interface.

Direct screen touch navigation has been met with tremendous success in the marketplace because of the ease of navigation and the absence of navigation hardware that is often bulky, difficult or unnatural to use, and often fragile. While direct screen touch navigation overcomes these issues, it is not ideal for some functions such as text input. Particularly, most tablet devices do not allow the user to input text with a full sized or nearly full sized QWERTY keyboard or other format keyboard for full typing capacity with both hands. Neither would the touch sensitive display provide sufficient responsiveness to accommodate normal typing even if size were not an issue. Further, many people simply prefer the feel and performance of hardware based text and data input, such as a slide out keyboard on a cell phone to the feel and performance of text input on a touch screen. Finally, the slim and compact form factor of such devices often trades battery life and memory size for the small and thin overall design.

### SUMMARY OF THE INVENTION

Accordingly, the present invention provides keyboard cases for tablet computers and methods for the fabrication and use thereof. In one embodiment, the case may be a clam shell keyboard case having a tablet panel with a hollowed out bed configured to receive and hold a tablet computer and a keyboard panel having a keyboard that can communicate with the tablet computer for the purpose of inputing data into and/or controlling the tablet computer. The tablet panel and the keyboard panels are typically joined by a hinge allowing the panels to articulate and move with respect to one another. In some embodiments, the tablet computer can be inserted into the tablet panel by snapping or otherwise fitting into the hollowed out bed. Once engaged, the keyboard can be used in connection with the tablet computer. Once use of the keyboard is completed, the tablet can remain in place and use continued via the touch screen navigation provided with most tablet computers. Alternatively, if use of the tablet computer is compete, then the tablet and keyboard panels can be closed together thus substantially completely hiding the tablet computer there between and providing a protective case thereof. Once use of the tablet computer is again desired, the panels may be actuated apart to expose the tablet for use. If use of the tablet without the keyboard is desired, the tablet can be readily removed from the tablet panel of the case by popping or snapping it out of place. In some embodiments, such removal will employ a slight deformation of the tablet panel.

### BRIEF DESCRIPTION OF FIGURES

FIG. 1 is a front perspective view of a tablet computer case in an open position in accordance with one embodiment of the present invention.

FIG. 2 is a front perspective view of a tablet computer case in an open position with a tablet computer held therein in accordance with one embodiment of the present invention.

FIG. 3 is a front perspective view of a tablet computer case in a closed position in accordance with one embodiment of the present invention.

FIG. 4 is a cut away view of a tablet panel having a pin connector and a tablet computer aligned to be placed in the tablet panel and engage the pin connector.

### DETAILED DESCRIPTION OF THE INVENTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “the hinge” includes one or more of such hinges, and reference to “a port” includes reference to one or more of such ports.

### DEFINITIONS

In describing and claiming the present invention, the following terminology will be used in accordance with the definitions set forth below.

As used herein, the term “tablet computer” refers to any single piece computing device having a visual output or screen on one side of a substantially flat or planar casing, inside of which, the entire computing device (i.e. all computing components) is substantially contained. In some aspects, such tablet computers may have a touch sensitive or navigation screen.

As used herein, the term “communication connector or pin connector” refers to any device or mechanism that allows input or output communication, or both, with a computing device. In some aspects of the present invention, a communication connector can be a wireless connector, such as a WiFi, a Bluetooth, or other radio frequency connector.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

### INVENTION

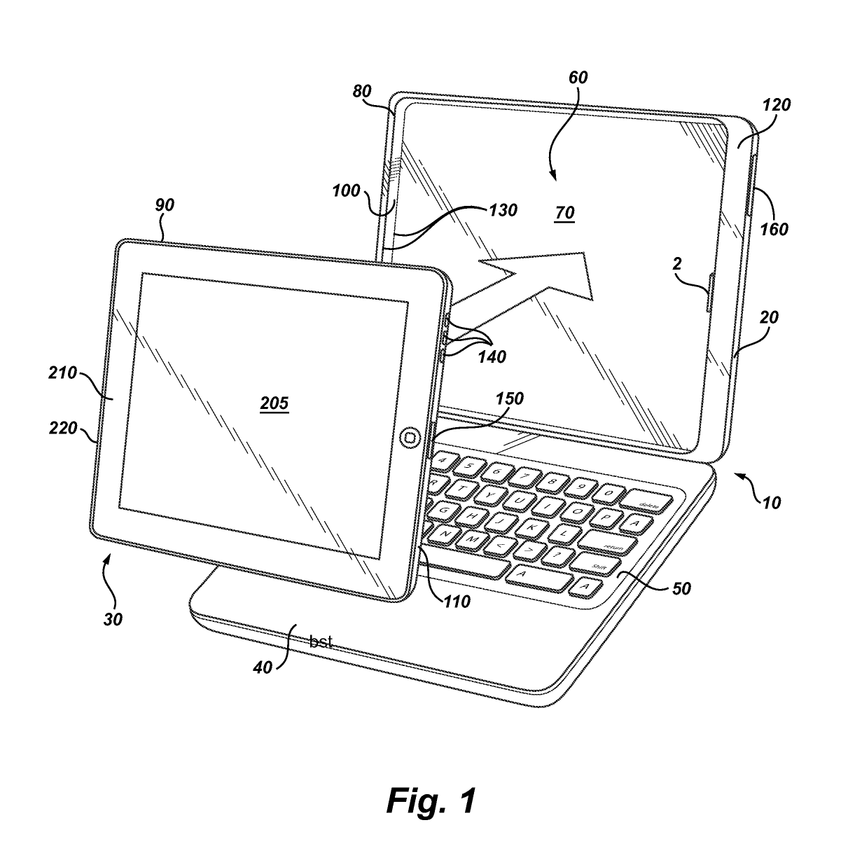

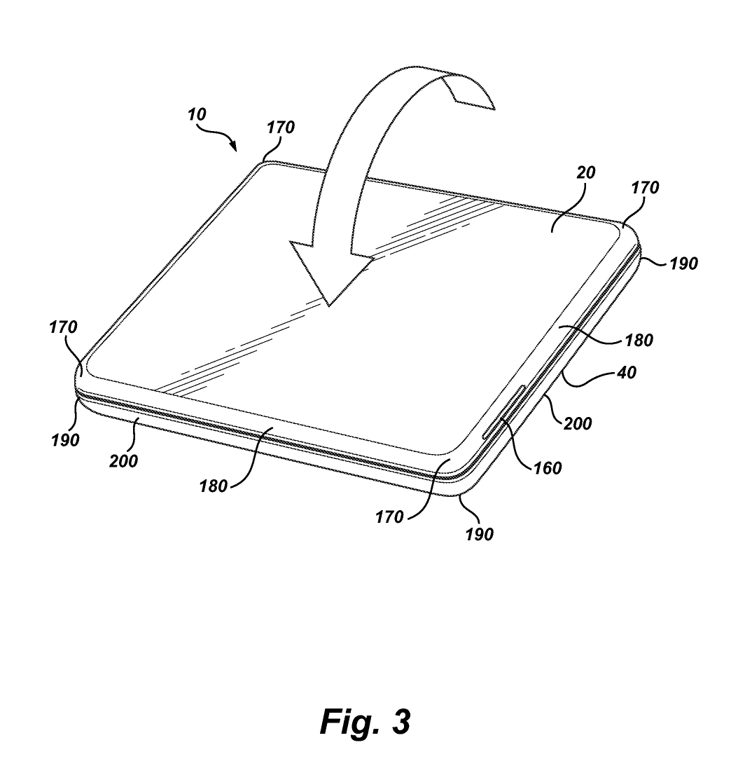

The present invention provides a tablet computer case, such as a clam shell keyboard case, and methods for the use thereof. In one aspect, such a case may include components that expand the capacity and input options of the tablet computer. Referring now to FIG. 1, the tablet computer case 10 may include a tablet panel 20 configured to releasably engage and hold a tablet computer 30 of a predetermined size and shape, and a keyboard panel 40 having a keyboard 50. A hinge (not shown) rotatably attaches the two panels, and allows the case to be opened and closed as shown in FIG. 3. When a tablet computer is fit into the tablet panel, the keyboard communicates with the tablet computer and is able to provide text input and optionally control other functions.

Referring again to FIG. 1, in some aspects of the invention, the tablet panel 20 can have a hollowed out bed 60 defined by a recessed back surface 70 and a raised perimeter edge 80 extending along, and in some aspects around, the recessed back surface. Such perimeter edge can be continuous or discontinuous as further discussed herein. In some aspects, the perimeter edge may extend along all sides of the hollowed out bed, and in some other aspects, the perimeter edge may extend along only one, two, or three sides of the hollowed out bed. In some aspects, the perimeter may be open. In others the perimeter may be closed.

In some embodiments, the perimeter edge may have an internal shape and/or size substantially matching, or corresponding to, a shape and size of an external perimeter edge 90 of the tablet computer 30, which is to be held in the hollowed out bed 60. In some aspects, the internal shape and/or size may match along at least one external perimeter edge of the tablet computer. In another aspect, the internal shape and/or size may match along at least two external perimeter edges of the tablet computer. In a further aspect, the internal shape and/or size may match along at least three external perimeter edges of the tablet computer. In yet another aspect, the internal shape and/or size may match along four external perimeter edges of the tablet computer. In yet another aspect, the internal shape/size match may extend along, the entire, or substantially the entire external perimeter of the tablet computer. As the shape and size of tablet computer perimeters can vary, so can the shape and size of the perimeter edge vary. In some aspects, the shape may be a polygon. In another aspect, the shape may be a quadrilateral. In yet another aspect, the shape may be substantially square. In a further aspect, the shape may be substantially rectangular. Furthermore, while the corners of the hollowed out bed may be sharp with a vertex, in some aspects, the corners may be rounded. In one aspect, at least one corner may be rounded. In another aspect, two corners may be rounded. In a further aspect, all corners may be rounded. In one embodiment, the shape of the hollowed out bed may have a shape and size substantially matching a shape and size of an iPad® brand tablet computer. In some embodiments, the tablet computer held in the hollowed out bed may be an iPad® brand tablet computer.

As also shown in FIG. 1, the raised perimeter edge 80 of the hollowed out bed may in some aspects, have a flat inwardly facing surface 100. In some embodiments of the present invention, the flat inwardly facing surface may have a plane that intersects a plane in which the recessed back surface 60 resides. In one embodiment, the plane of the flat inwardly facing surface on the raised edge may intersect a plane in which the recessed back surface resides at an angle of from about 70 degrees to about 110 degrees. In yet another embodiment, the angle of intersection may be from about 80 degrees to about 90 degrees. In a further embodiment, the angle of intersection may be about 90 degrees. In some embodiments of the invention, the flat inwardly facing surface of the raised perimeter edge may abut an external perimeter edge 90 of the tablet computer 30 when the tablet computer is fit into place and held in the hollowed out bed 70. In some aspects, the external perimeter edge 90 of the tablet computer may include a flat outwardly facing surface 110. In another aspect, the edge may have a rounded, arcuate, or curved shape. In another aspect, the shape of the edge may be pointed or have a ridge or vertex. In some aspects, the abutment of the external perimeter edge of the tablet with the flat inwardly facing surface of the raised perimeter edge may aid in holding the tablet computer in place in the hollowed out bed. In some aspects, abutment of opposing flat edges may further increase the hold of the tablet computer by the tablet panel. In yet other aspects, aspects, the abutment of the flat inwardly facing surface and the external perimeter edge of the tablet computer may extend along at least one side of the raised perimeter edge. In another aspect, the abutment of the flat inwardly facing surface and the external perimeter edge of the tablet computer may extend along at least two sides of the raised perimeter edge. In a further aspect, the abutment of the flat inwardly facing surface and the external perimeter edge of the tablet computer may extend along at least three sides of the raised perimeter edge. In yet a further aspect, the abutment of the flat inwardly facing surface and the external perimeter edge of the tablet computer may extend along all sides of the raised perimeter edge. In yet another aspect, the abutment of the abutment of the flat inwardly facing surface and the external perimeter edge of the tablet computer may extend along the corners of the raised perimeter edge. In an additional aspect, the abutment of the flat inwardly facing surface and the external perimeter edge of the tablet computer may extend along substantially the entire length of the entire raised perimeter edge, whether continuous or discontinuous. In one embodiment, the raised perimeter edge may bound, surround, or frame, substantially the entire hollowed out bed and have a substantially flat inwardly facing surface along substantially the entire length thereof. Furthermore, in some aspects, the abutment of the flat inwardly facing surface and the external perimeter edge of the tablet computer may extend along substantially the entire raised perimeter edge bounding, surrounding, or framing substantially the entire hollowed out bed.

In some embodiments, the raised perimeter edge may also have a top surface 120 and a height 130 to which it extends above the recessed back surface. In some aspects, the height of the raised perimeter edge may contribute to, or define, a depth of the hollowed out bed 60. In some aspects, the depth of the hollowed out bed may substantially match the thickness of the tablet computer.

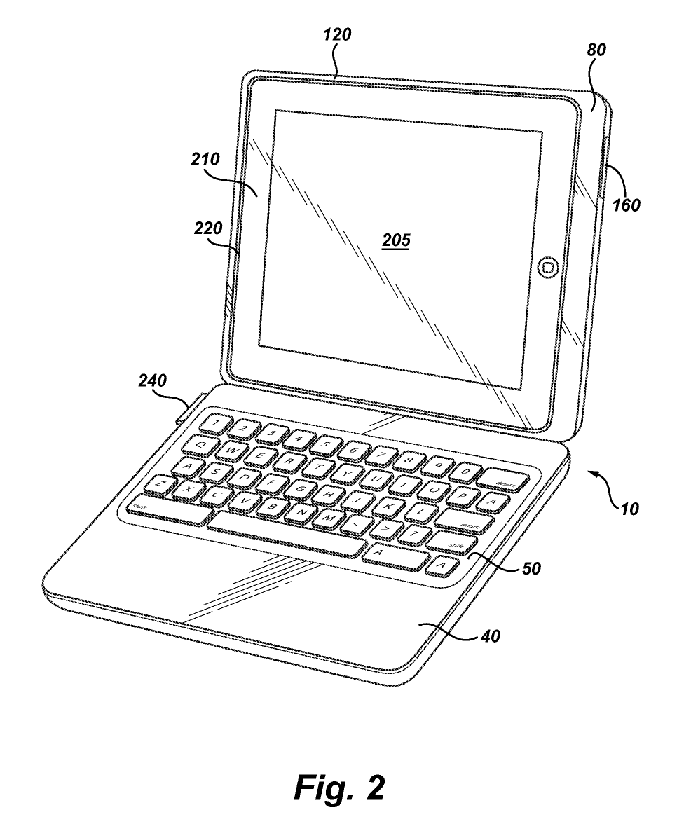

Referring now to FIG. 2, a tablet computer 30 is shown being held in the hollowed out bed (not shown) of a tablet panel 20. The tablet panel has a raised perimeter edge 80 extending around a recessed back surface (not shown). The raised perimeter edge has a top surface 120. The depth of the hollowed out bed substantially matches the thickness of the tablet computer so that the screen 205 of the tablet computer is in substantially the same plane with the top surface of the raised perimeter edge. However, in some aspects, the depth of the hollowed out bed and the thickness of the tablet computer may be different. In one aspect, the top surface of the perimeter edge may extend above the screen of the tablet computer when the tablet computer is fit into the hollowed out bed. In another aspect, the screen of the tablet computer may extend above the top surface of the perimeter edge when the tablet is fit into the hollowed out bed. Such embodiments and others allow the screen of the tablet computer to be readily exposed for use by a user. In some aspects, the entire screen of the tablet computer, or substantially the entire screen may be exposed, or fully exposed, when the tablet computer is engaged in the hollowed out bed of the tablet panel. In another aspect, substantially the entire screen and bezel 210 of the tablet computer may be exposed. In yet another aspect, a front surface of a casing edge 220 of a tablet computer may be substantially exposed. In a further embodiment, the front surface of the casing edge of a tablet computer may be substantially exposed, or entirely exposed, along two opposing ends of the tablet computer.

Regarding the recessed back surface 70 of the hollowed out bed 60, any shape, configuration, or texture conducive to the engagement of a tablet computer into the hollowed out bed may be used. However, in one aspect, the recessed back surface may be solid, or unbroken, at all points within the perimeter edge.

Returning again to the raised perimeter edge 80 of the tablet panel 20, as previously mentioned, in some embodiments of the present invention, the perimeter may have one or more openings or gaps. In one aspect of the invention, such an opening may be located at a location corresponding to a functional feature on the tablet computer 30. Examples of such functional features may include without limitation, buttons, pin connectors, speakers, headphone jacks, dials, switches, or slide bars. As shown in FIG. 1, speakers 140 substantially correspond to openings 160. However, any number of openings, including holes, may be located as needed in order to provide full user access to any controls or features located on the tablet computer. In one aspect, the opening may correspond to the location of a button. In another aspect, the opening may correspond to the location of a pin connector.

In addition to the foregoing, the tablet panel 20 be shaped with a number of different shape features on its exterior surfaces, including exterior edges. Referring to FIG. 3, is shown and embodiment of a clamshell tablet case 10 of the present invention in a close position. In this position the tablet panel 20 has been actuated using the hinge (not shown) to bring the tablet panel and the keyboard panel 40 together in a closed configuration. In this embodiment, the tablet panel corners 170 are rounded. Further, the external edges 180 of the tablet panel are also rounded. In addition, the edges 190 of the keyboard panel are also rounded and the external edges 200 of the keyboard panel are rounded as well. However, it is to be understood that the external corners and edges of both the tablet panel and the keyboard panel may take any configuration desired in order to impart a desired property or function. In one aspect, the corners and/or edges may have a vertex. In another aspect, the edges and/or corners may be tapered. In yet another aspect, the edges and/or corners may be flat. In some aspects, the corners may be rounded with the edges being flat. In other aspects, the corners may be rounded with the edges also rounded. In this embodiment, the corners will present a surface that is simultaneously convex in both the horizontal and vertical planes.

In addition to variation in the edge and corner features, the thickness of both the tablet panel 20 and the keyboard panel 40 can be varied in order to provide a desired effect or design. Thickness and weight are typically of great concern in personal electronics. In one aspect, the keyboard panel can have a thickness that is substantially greater than the tablet panel. In another aspect, the keyboard panel can have a thickness that is substantially equal to that of the tablet panel. In a further aspect, the keyboard panel can have a thickness that is substantially less than the thickness of the tablet panel.

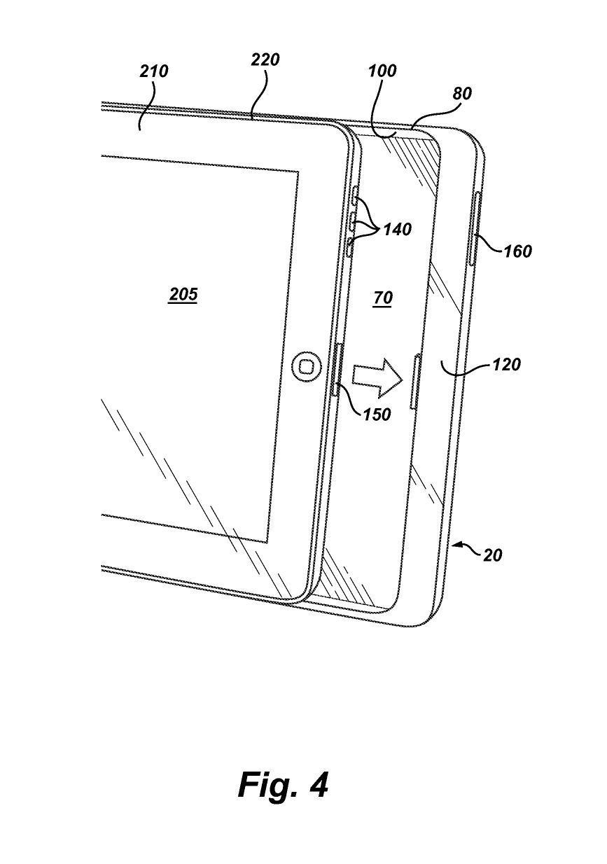

Referring now to FIG. 4 is shown an embodiment of the present invention depicting insertion of a tablet computer 30 into a tablet panel 20 of the present invention. In such embodiment, the raised perimeter edge 80 includes a pin connector 230. Such pin connector can typically be located at a location on the raised edge which substantially matches a pin connector on the tablet computer. As such, the pin connector on the tablet can engage the pin connector on the perimeter edge of the hollowed out bed when the tablet is held in the hollowed out bed. The pin connector as previously mentioned can be one mechanism for communication between the keyboard and the tablet computer.

In use, the tablet computer 30 can be snapped or fit into place in the tablet panel 20 of the clamshell case of the present invention in a number of ways. Typically, one side of an external edge 90 of the tablet computer is placed against one inwardly facing surface 100 of the raised peripheral edge 80 and then the tablet computer aligned with the hollowed out bed in the tablet panel. The tablet computer is then slid, fit, or snapped into place. When the tablet panel includes a pin connector, the peripheral edge of the tablet computer containing a corresponding pin connector is aligned therewith and then the unit slid, fit, or otherwise snapped into place.

Referring again to FIG. 2, it is noted that they keyboard panel 40 may include a pin connector or other input 240. Such pin connector may be of any size or shape required to accomplish a desired purpose or provide a product with specific characteristics. In some aspects, the pin connector may be a USB port. In another aspect it may be a 30 pin connector used on products produced by Apple company, such as the iPad®. Moreover, this is true for the other pin connecters recited herein. In addition to a pin connector, the connector or other input 240 may include a power input.

A wide variety of keyboard construction and configuration may be used for the keyboard in the keyboard panel. Standard QWERTY configuration of keys as well as a number of special control keys can be included as desired. Spacing and enter keys may also be included. Further, the keyboard can include keys capable of special programming so as to provide specific function or symbols when activated or depressed. Further, the keys may be individually suspended. In some aspects the keys may be programmed to type a corresponding letter or symbol. In other aspects, some keys may be configured or programmed to navigate or otherwise control the function of the tablet computer. In some aspects, the keys may have spaces therebetween such as the “chiclet” type keys or without substantial spaces therebetween, such as provided by a standard laptop or other type of keyboard.

The materials used in the fabrication of the case of the present invention may include any suitable materials required to achieve a given purpose. Examples of suitable materials include without limitation polymer and plastics, metals and alloys, and ceramics. Those of ordinary skill in the art will recognize materials suitable for the varying components in order to obtain desired function. In some aspects, the case of the present invention may be fabricated by use of molding, including injection molding, or other fabrication techniques recognized by those of ordinary skill in the art and which are typically used in the fabrication of personal electronic devices

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A clam shell keyboard case for a tablet computer comprising:
a tablet panel with a hollowed out bed defined by a recessed back surface and a raised perimeter edge extending around the recessed back surface, said perimeter edge having an internal shape and size substantially matching a shape and size of an external perimeter edge of a tablet computer to be held in the hollowed out bed, said perimeter edge further having a substantially flat inwardly facing surface which abuts an external perimeter edge of the tablet computer when the tablet computer is fit into place and held in the hollowed out bed; and
a keyboard panel with a keyboard, said keyboard panel hingedly coupled to the tablet panel.

2. The keyboard case of claim 1, wherein the internal shape of the perimeter edge is substantially rectangle.

3. The keyboard case of claim 2, wherein the internal shape of the perimeter edge has rounded corners.

4. The keyboard case of claim 1, wherein the flat inwardly facing surface of the perimeter edge of the hollowed out bed abuts substantially the entire external perimeter edge of the tablet computer.

5. The keyboard case of claim 1, wherein the external perimeter edge of the tablet computer includes a flat outwardly facing surface.

6. The keyboard case of claim 1, wherein the abutment of the external edge of the tablet computer with the substantially flat inwardly facing surface of the perimeter edge aids in holding the tablet computer in place in the hollowed out bed.

7. The keyboard case of claim 1, wherein the perimeter edge of the hollowed out bed has a top surface and the hollowed out bed has a depth substantially matching a thickness of the tablet computer, so that a screen of the tablet computer is substantially in a same plane with the top surface of the perimeter edge of the hollowed out bed.

8. The keyboard case of claim 1, wherein the recessed back surface is continuously solid at all points within the perimeter edge.

9. The keyboard case of claim 1, further comprising at least one opening in the perimeter edge of the hollowed out bed located at a location corresponding to a button, speaker, a pin connector, or headphone jack on the tablet computer, such that the button, speaker, or headphone jack on the tablet can be accessed when the tablet is held in the hollowed out bed.

10. The keyboard case of claim 9, wherein the opening in the perimeter edge corresponds to the location of a button on the tablet computer.

11. The keyboard case of claim 9, wherein the opening in the perimeter edge corresponds to the location of a pin connector on the tablet computer.

12. The keyboard case of claim 1, wherein the tablet panel has rounded external corners.

13. The keyboard case of claim 1, wherein the tablet panel has rounded external edges.

14. The keyboard case of claim 1, wherein the keyboard panel has rounded corners.

15. The keyboard case of claim 1, wherein the keyboard panel has rounded external edges.

16. The keyboard case of claim 1, wherein the keyboard panel has a thickness substantially equal to or less than a thickness of the tablet panel.

17. The keyboard case of claim 1, wherein a screen of the tablet is fully exposed when the tablet is engaged in the hollowed out bed of the tablet panel.

18. The keyboard case of claim 1, wherein the raised perimeter edge of the hollowed out bed includes a pin connector at a location substantially matching a location of a pin connector on the tablet, such that the pin connector on the tablet can engage the pin connector on the perimeter edge of the hollowed out bed when the tablet is held in the hollowed out bed.

19. The keyboard case of claim 1, wherein the tablet computer has a size and shape substantially matching a size and shape of an Ipad® brand tablet computer.

20. The keyboard case of claim 1, wherein the tablet computer securely fits into the hollowed out bed by snapping the tablet computer into the hollowed out bed.
